(19) United States
(12) Patent Application Publication
(10) Pub. No.: US 2004/0107240 A1
(43) Pub. Date: Jun. 3, 2004

(54) Method and system for intertask messaging between multiple processors

(75) Inventors: Boris Zabarski, Tel Aviv (IL); Dorit Pardo, Ramat-Hasharon (IL); Yaacov Ben-Simon, Beer Sheva (IL)

Correspondence Address: HUNTON & WILLIAMS LLP, INTELLECTUAL PROPERTY DEPARTMENT, 1900 K STREET, N.W., SUITE 1200, WASHINGTON, DC, 20006-1109, US

(73) Assignee: Globespan Virata Incorporated

(21) Appl. No.: 10/307,296

(22) Filed: Dec. 2, 2002

(51) Int. Cl. G06F 15/16

(52) U.S. Cl. 709/201

(57) ABSTRACT

A system and method for communicating messages between tasks on separate processors in a multiprocessor system are disclosed herein. A mediator task having a separate incoming message queue is used to handle message(s) from remote task(s) on other processor(s). A message from a remote task intended for a local task of a local processor is stored in the message queue of the mediator task. During an execution of the mediator task on the local processor, the mediator task is adapted to transfer the message from its message queue to the message queue of the intended local task, either directly or via another task. The present invention finds particular benefit in data processing in network devices.

### FIELD OF THE INVENTION

The present invention relates generally to the transmission of messages in multiprocessor systems and more particularly to using a mediator task to synchronize the transmission of a message from a task of one processor to a task of another processor.

### BACKGROUND OF THE INVENTION

Various systems implementing a number of interconnected processors have been developed to provide increased computational power without the limitations of cost, complexity and other factors involved in the use of a single, more powerful processor. Each processor of a multiprocessor system typically executes one or more tasks related to the overall process performed by the system. In the course of operation, a task of one processor may generate an intertask message intended for one or more other tasks located on the same local processor and/or on one or more remote processors. These messages can include, for example, data generated or obtained by the sending task for use by the receiving task, a directive from the sending task instructing the receiving task to perform some operation or to forego the performance of some operation, a signal indicating the occurrence or non-occurrence of an event, and the like.

Generally, each task of a processor capable of receiving messages includes an incoming message queue implemented in the internal memory resources of the processor. When a task sends a message to another task, the sending task places the message in the incoming message queue of the destination task and notifies the destination task. During its execution cycle, the destination task sequentially retrieves one or more of the messages at the front of its queue and processes the messages accordingly.

The transmission of a message between tasks of in a single processor system often is relatively uncomplicated as in many instances only one task can access a certain message queue during any given execution cycle since only one task can be executed by the processor during the given execution cycle. However, in multiprocessor systems the synchronization of messages often is necessary to prevent a race condition as a certain message queue associated with a task potentially could be accessed at essentially the same time by multiple tasks running concurrently on multiple processors. For example, a task of a local processor and a task of a remote processor could attempt to access the incoming message queue of another task on the local processor. Alternatively, a task of one remote processor and a task of another remote processor could simultaneously attempt to access the incoming message queue of a task on a local processor. Consequently, care often is taken to ensure that the incoming message queue associated with a task of a processor is not corrupted by access to the message queue by multiple tasks at the same time.

To illustrate, assume that a first task on a first processor (T1P1) attempts to send a message to a first task on a second processor (T1P2) at the same time that a second task on the second processor (T2P2) attempts to send a message to T1P2. T1P1 and T2P2 attempt to read the write pointer of the target message queue of T1P2 essentially at the same time. Assuming that the target message queue is not full, each of T1P1 and T2P2 attempts to write a message to the target message queue. However, since each of the sending tasks have the same write pointer, the message from one of the sending tasks most likely will overwrite the message from the other sending task in the target message queue. As a result, one of the messages will be lost. The message queue can be similarly corrupted when, for example, T2P1 attempts to read a message from the message queue of T2P1 at the same time that T1P1 attempts to write a message to the queue.

Techniques developed to minimize or eliminate race conditions in interprocessor communications typically include the use of mutual exclusion schemes, such as semaphores, spin locks, and, in particular, hardware locks at the processors. These mutual exclusion schemes typically are adapted to prevent the simultaneous access of resources of a processor by multiple tasks, remote or local. For example, when a local task accesses a protected resource of the processor (e.g., internal memory), the hardware lock is set by the local task, thereby preventing access by tasks external to the processor. After the local task is done using the protected resource, the local task releases the hardware lock, allowing access to the protected resource by other tasks.

While hardware locks and other mutual exclusion techniques can be implemented to minimize or eliminate race conditions, such implementations generally have a number of limitations. For one, hardware locks and other mutual exclusion techniques often are relatively expensive to implement in a processor, and often increase the complexity of the processor. Further, these mutual exclusion schemes often incur a processing overhead when, for example, a task, either local or remote, attempts to access a resource protected by a hardware lock. When accessing the resource, the task typically checks and claims the hardware lock if available or busy waits if the lock is unavailable. In either case, considerable processing overhead results from attempts to access, claim, or release the lock, as well as the busy wait resulting from an unavailable hardware lock.

Accordingly, an improved technique for synchronizing intertask messages between multiple processors would be advantageous.

### SUMMARY OF THE INVENTION

The present invention mitigates or solves the above-identified limitations in known solutions, as well as other unspecified deficiencies in known solutions. A number of advantages associated with the present invention are readily evident to those skilled in the art, including economy of design and resources, transparent operation, cost savings, etc.

In accordance with one embodiment of the present invention, a method for communicating at least one message between a first processor and a second processor is provided. The method comprises storing a message from a task of the first processor in a first queue associated with a first task of the second processor, the message being intended for a second task of the second processor and transferring the message from the first queue to a second queue associated with the second task during an execution of the first task by the second processor.

In accordance with another embodiment of the present invention, a system for communicating at least one message between processors is provided. The system comprises a first processor, a first queue being adapted to store at least one message intended for a first task of the first processor, and a second queue being adapted to store at least one message from at least one task of a second processor, the at least one message being intended for the first task of the first processor. The system further comprises a first mediator task being adapted to transfer the at least one message intended for the first task from the second queue to the first queue during an execution of the first mediator task by the first processor.

In accordance with another embodiment of the present invention, a multiprocessor system is provided. The system comprises a first processor having at least one task adapted to generate at least one message intended for at least one task of at least one other processor and a second processor operably connected to the first processor. The second processor includes a first task, a first queue being adapted to store at least one message intended for the first task, and a second queue being adapted to store at least one message from at least one task of the first processor, the at least one message being intended for the first task of the second processor. The second task is adapted to transfer, during an execution of the second task by the second processor, the at least one message from the second queue to the first queue for use by the first task.

In accordance with yet another embodiment of the present invention, a computer readable medium is provided. The computer readable medium comprises a set of instructions being adapted to manipulate a second processor to store a message from a task of a first processor in a first queue of the second processor associated with a first task of the second processor, the message being intended for a second task of the second processor and transfer the message from the first queue to a second queue during an execution of the first task by the second processor, the second queue being associated with the second task.

In accordance with an additional embodiment of the present invention, a system for communicating messages between processors is provided. The system comprises a plurality of interconnected processors. Each processor includes a first message queue, a first task operably connected to the first message queue, a plurality of mediator message queues, and a plurality of mediator tasks. Each mediator task being operably connected to a different mediator message queue of the plurality of message queues and the first message queue, each mediator task being associated with a different processor of a subset of the plurality of processors, and wherein each mediator task of a processor is adapted to transfer at least one message from the corresponding mediator message queue to the first message queue of the processor during an execution of the mediator task by the processor, the at least one message being stored by a first task of another processor in the corresponding mediator message queue and intended for the first task of the processor.

### BRIEF DESCRIPTION OF THE DRAWINGS

The purpose and advantages of the present invention will be apparent to those of ordinary skill in the art from the following detailed description in conjunction with the appended drawings in which like reference characters are used to indicate like elements, and in which:

FIG. 1 is a schematic diagram illustrating an exemplary multiprocessor system having a mediator task for intertask communication in accordance with at least one embodiment of the present invention.

FIG. 2 is a flow diagram illustrating an exemplary method for intertask message communication in a multiprocessor system in accordance with at least one embodiment of the present invention.

FIG. 3 is a flow diagram illustrating an exemplary operation of the multiprocessor system of FIG. 1 in accordance with at least one embodiment of the present invention.

### DETAILED DESCRIPTION OF THE INVENTION

The following description is intended to convey a thorough understanding of the present invention by providing a number of specific embodiments and details involving synchronization of intertask messages in multiprocessor systems. It is understood, however, that the present invention is not limited to these specific embodiments and details, which are exemplary only. It is further understood that one possessing ordinary skill in the art, in light of known systems and methods, would appreciate the use of the invention for its intended purposes and benefits in any number of alternative embodiments, depending upon specific design and other needs.

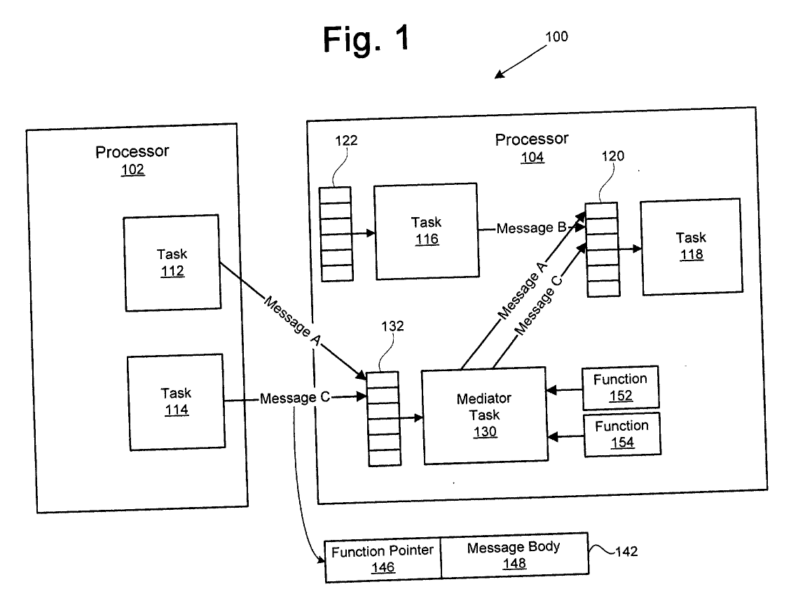

FIGS. 1-3 illustrate an exemplary system and method for communicating messages between tasks on separate processors in a multiprocessor system. In at least one embodiment, a processor implements one or more mediator tasks, each having a separate incoming message queue to receive message(s) from remote task(s) on other processor(s). During an execution of the mediator task on the local processor, the mediator task is adapted to transfer the message from its message queue to the incoming message queue of the intended local task.

The term processor generally refers to any of a variety of digital circuit devices adapted to manipulate data or other information by performing one or more tasks embodied as one or more sets of instructions executable by the digital circuit device. Processors typically include some form of an arithmetic logical unit (ALU) adapted to perform arithmetic and/or logical functions, internal memory resources such as registers, cache, on-chip random access memory (RAM) or read only memory (ROM), and the like, and a control unit adapted to load instructions and/or data from external memory and/or the internal memory resources and execute the instructions using the ALU and other processor resources as appropriate. Examples of processors include microprocessors (also known as central processing units or CPUs), microcontrollers, and the like.

The term task typically refers to a sequence of one or more actions performed by the processor to perform a certain function or to obtain a desired result. To illustrate, a task can include a simple operation such as adding two numbers or can include a more complex operation such as implementing one or more layers of a network protocol stack to process a network packet. Tasks are also commonly referred to as processes, programs, threads, and the like. In at least one embodiment, a task is implemented as a set of executable instructions that, when executed by a processor, manipulate the processor to perform the desired function or obtain the desired result. The set of executable instructions can be stored in memory external to the processor (e.g., RAM) and loaded from the external memory for execution by the processor, the executable instructions can be loaded in the internal memory resources of the processor (e.g., ROM) for subsequent execution by the processor, or a combination thereof.

The terms remote and local are used herein to provide a contextual relation between a source and a destination of a interprocessor message, respectively, and are not intended to indicate a particular geographical or spatial arrangement of the source or destination. Accordingly, a remote processor includes a processor that sends an interprocessor message and a local processor includes a processor that receives the message. Likewise, the a remote task is a processor task executed on a remote processor and a local task is a processor task executed on a local processor. Furthermore, the terms remote and local are relative, as a processor may be a local processor and/or a remote processor to other processors.

Referring now to FIG. 1, an exemplary multiprocessor system 100 is illustrated in accordance with at least one embodiment of the present invention. In the illustrated example, the system 100 includes a plurality of processors including a processor 102 and a processor 104. For the following discussion, it is assumed that one or more messages are generated at processor 102 and intended for receipt by one or more tasks of the processor 104. Therefore, the processor 102 and the processor 104 are herein referred to as the remote processor 102 and the local processor 104, respectively. The remote processor 102 includes one or more remote tasks, such as remote processor tasks 112, 114 and the local processor 104 includes one or more local tasks, such as local processor tasks 116, 118.

In at least one embodiment, an incoming message queue (e.g., message queues 120, 122) is used by a task to receive messages from other tasks. The message queues, in one embodiment, are implemented as part of the internal memory resources of the respective processor, such as in registers, cache, on-chip RAM, and the like. Alternatively, some or all of the message queues may be implemented in external memory, such as system RAM, using the guidelines provided herein. The message queues preferably are implemented as first-in, first-out (FIFO) queues (e.g., circular queues), but may be implemented using any of a variety of buffering techniques, such as a last-in, first-out (LIFO) stack, a priority-based queue, and the like.

The processors 102, 104 preferably are adapted to support non-preemptive task execution whereby the execution of an operation of one task generally cannot be interrupted by another task. For example, a load or store operation performed by one task during its execution cycle cannot be interrupted by another task during the execution of the load or store operation in typical non-preemptive processors. Such non-preemptive operations may be considered “atomic” operations, since they are either performed uninterrupted or not at all. For example, the processors 102, 104 could be adapted to perform load and store operations in one processing cycle, thereby precluding an interruption of the operations by another processor or task. Accordingly, in this case, the transfer of a message from one local task to another local task and/or the removal of a message from the incoming message queue of a task may be considered an “atomic” operation.

The local processor 104, in at least one embodiment, further includes a mediator task 130 associated with the remote processor 102. The mediator task 130, as with the other tasks 116, 118, may be provided a portion of the internal memory resources of the local processor 104 for use as an incoming message queue 132. Furthermore, like the other tasks, an execution slice of the local processor 104 is assigned for the execution of the mediator task 130 using any of a variety of preferably non-preemptive scheduling techniques. However, while the local tasks 116, 118, typically are adapted to perform one or more operations related to the overall process to be performed by the multiprocessor system 100, the mediator task 130 is adapted to act as an interface for messages from remote processor 102 intended for the tasks 116, 118 of the local processor 104. When one of the remote tasks 112, 114 generates a message intended for one or more local tasks 116, 118 of the local processor 104, the remote task can be adapted to store the message in the incoming message queue 132 of the mediator task 130 rather than attempting to store the message directly in the message queue of the intended local task.

Furthermore, in at least one embodiment, the mediator task 130 is associated with a single remote processor to prevent the simultaneous access of the message queue 132 by tasks of two or more remote processors. In this case, the local processor 104 can implement a different mediator task 130 for each of the remote processor(s) 102 connected to the local processor 104.

Since the mediator task 130 may be associated with a single remote processor, various techniques may be implemented to prevent erroneous access to the mediator task 130 by a different remote processor. One technique includes adapting (e.g., programming) each remote task of a remote processor to send messages intended for a local processor only to the mediator task 130 of the local processor that is associated with the remote processor. For example, the remote tasks 112, 114 of the remote processor 102 could be programmed to store any messages for the tasks 116, 118 at a memory address associated with the message queue 132 of the designated mediator task 130. Alternatively, each remote task 112, 114 could be adapted to provide an identifier associated with the remote processor 102 with each message sent to the local processor 104. A component internal or external to the local processor 104 could then select the appropriate mediator tasks 130 for messages from remote processors based in part on the processor identifiers associated with the messages. Another technique to prevent erroneous access of the message queues 132 of the mediator task 130 includes providing a separate physical connection between each remote processor and the local processor 104, each physical connection being associated with a different mediator task 130. Other techniques for preventing erroneous access to a message queue 132 of a mediator task 130 may be used without departing from the spirit or the scope of the present invention.

During its execution cycle, the mediator task 130 is adapted to check its message queue 132 for any messages contained therein. If a message is present, the mediator task 130 can be adapted to determine the local task for which the message is intended and then transfer the message (or a copy thereof) from its message queue 132 to the message queue of the intended local task (e.g., incoming message queue 120 of task 118). The mediator task 130 can be adapted to determine the intended local tasks of a message in any of a variety of ways. In one embodiment, a remote task can be adapted to generate a message 142 having a function pointer field 146 and a message body field 148. The function pointer field 146 could have one or more pointers to one or more message transfer functions 152, 154 accessible to the mediator task 130. These functions 152, 154 include instructions executed by the mediator task 130 to direct the processor 104 to transfer the associated message in the message queue 132 to the message queue of the corresponding local task. The message transfer functions 152, 154 can be implemented in any of a variety of ways, such as a set of processor-executable instructions, a dynamic link library (DLL) or device driver executed by the mediator task 130, a stand-alone executable initiated by the mediator task 130, and the like.

The mediator task 130 preferably implements a different message transfer function for each local task. When a remote task sends a message intended for a local task, the remote task generates a message 142 having the body of the message in the message body 148 and places a function pointer associated with the intended local task in the function pointer field 146. Upon receipt of the message 142, the processor 102 stores the function pointer of the function pointer field 146 and the message body of the message body field 148 into the message queue 132. When the inserted function pointer/message is up for processing by the mediator task 130, the mediator task uses the function pointer to execute the referenced message transfer function, where the referenced function directs the mediator task 130 to transfer the message from the message queue 132 to the message queue of the local task associated with the referenced function.

To illustrate, assume that function 152 is adapted for the transfer of messages from the message queue 132 to the message queue 122 of the local task 116 and function 152 is adapted for the transfer of messages from the message queue 132 to the message queue 120 of the local task 118. If either of the remote tasks 112, 114 intends to send a message to the local task 116, the remote task generates a message 142 having a function pointer to the function 152 in the function pointer field 146. When processing the message 142, the mediator task 130 executes the function 152 referenced by the function pointer field 146, where the function 152 directs the transfer of the message from the message queue 132 to the message queue 122. Likewise, when either of the remote tasks 112, 114 intends to send a message to the local task 118, they can generate a message 142 having a function pointer to the function 154 in the function pointer field 146. Upon processing of this message 142, the mediator task 130 executes the function 154 referenced by the function pointer field 146, where the function 154 directs the transfer of the message from the message queue 132 to the message queue 120.

Other methods of indicating an intended destination of a message from a remote task may be implemented by those skilled in the art, using the guidelines provided herein. For example, each local task of a local processor could have an ID value known to the remote tasks 112, 114. When a message is generated, the ID value corresponding to the intended local task(s) are added to a target ID field of the message. Accordingly, the mediator task 130 can determine the destination(s) of the message by examining the target ID field of a message in the message queue 132 and then forward the corresponding message body to the message queue(s) of the intended local task(s). Alternatively, a known relation may exist between a remote task and one or more of the local tasks, whereby a message from the remote task is assumed to be intended for the specified local task(s). The message therefore could include a source ID field in addition to a message body, wherein the source ID field includes an indicator of the source remote task of the message. In this case, the mediator task 130 can determine the destination message queue(s) of the message body of the message based in part on the relationship of the identified remote task to one or more of the local tasks of the local processor 104.

The multiprocessor system 100 can be used in any of a variety of ways. To illustrate, in one embodiment, the multiprocessor system 100 is implemented in a network device adapted to process or otherwise manipulate network information (e.g., network packets) transmitted from one network device to another network device. Such network devices can include, but are not limited to, customer premises equipments (CPEs), access concentrators, wide area network (WAN) interfaces, digital subscriber line (DSL) modems, DSL access multiplexers (DSLAM), dial-up modems, switches, routers, bridges, optical network terminations (ONTs), optical line terminations (OLTs) optical network interface (ONIs), and the like. In this case, one or more processors of the multiprocessor system 100 can be used to perform one or more functions related to the processing of data by the device.

To demonstrate, the multiprocessor system 100 could be used to process or otherwise manipulate network data by implementing one or more network protocol stacks, such as Transmission Control Protocol/Internet Protocol (TCP/IP), Voice over IP (VoIP), Asynchronous Transfer Mode (ATM), and the like. The network protocol stack could be implemented using a combination of processors. For example, each processor could implement a different layer of the protocol stack. In this case, the results of one layer of the stack implemented by one processor could be passed to the processor implementing the next layer of the protocol stack as one or more intertask messages. Alternatively, the network protocol stack could be implemented on one processor or a subset of the processors, with another processor providing control signals and data via intertask messages between the processors.

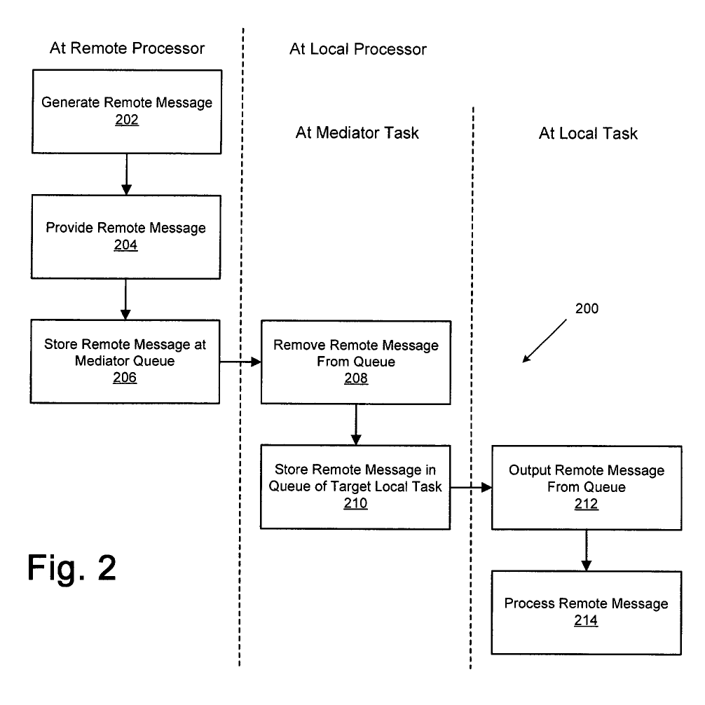

Referring now to FIG. 2, an exemplary method 200 for synchronizing intertask messages in a multiprocessor system is illustrated in accordance with at least one embodiment of the present invention. The method 200 initiates at step 202 whereby a remote task on a remote processor generates a message intended for one or more local tasks of a local processor. The message can include, for example, a function pointer to a message transfer function used to transfer the message from the message queue of the mediator task to the message queue of the local task associated with the referenced function. Alternatively, the message could include, for example, a target ID identifying the one or more local tasks for which the message is intended, or a source ID identifying the source task and/or source processor of the message. At step 204, the message is transmitted from the remote processor to the local processor. The connection between the remote processor and the local processor by which messages are transmitted can include any of a variety of transmission mediums and/or network topologies or combination of network topologies. For example, the processors could be connected via a bus, a star network interface, a ring network interface, and the like. Likewise, rather than using a single interface, each processor could be adapted to provide a separate interface for some or all of the remaining processors. In this case, each interface could be used by the mediator task corresponding to the remote processor connected to the interface.

At step 206, the message and any associated fields (e.g., function pointer field 146, FIG. 1) are stored in the incoming message queue of the mediator task of the local processor (e.g., message queue 132 of mediator task 130, FIG. 1) associated with the remote processor that provided the message. Recall that the mediator task associated with the remote processor can be determined based in part on an identifier provided with the message, the interface of the local processor used to receive the message, and the like. In at least one embodiment, the incoming message queue includes a FIFO queue implemented as, for example, a circular buffer having a read pointer, a write pointer, etc. In this case, the storing of the message can include storing the message at the internal memory location of the local processor referenced by the write pointer and then incrementing the write pointer.

During the execution of the mediator task by the local processor, the next message in the incoming message queue of the mediator task is identified for processing by the mediator task. Recall that the local processor may implement a different message transfer function for each local task and, therefore, a remote task can direct the mediator task to transfer a message to the intended local task by referencing the message transfer function associated with the intended local task. In this case, at step 208, the mediator task executes, or initiates the execution of, the message transfer function referenced by the function pointer of the message, where the message transfer function directs the mediator task to transfer the message from the message queue of the mediator task to the message queue of the local task associated with the referenced message transfer function. Alternatively, the message in the queue of the mediator task can include one or more identifiers of the source and/or the intended destination of the message. These identifier(s) can be examined by the mediator task to determine the one or more local tasks for which the message is intended. The local task(s) for which a message is intended can be determined in a number of ways, such as by examining an identifier included with the message, determining the source of the message, determining the route of the message, and the like.

At step 210, the message extracted from the mediator task's message queue at step 208 is stored in the message queue(s) of the one or more intended local task(s). As with the incoming message queue of the mediator task, the messages queues associated with the local tasks preferably include FIFO queues implemented in the internal memory of the local processor 104. The next message in the incoming message queue of an intended local task removed at step 212 during a concurrent or subsequent execution of the local task and processed as appropriate at step 214.

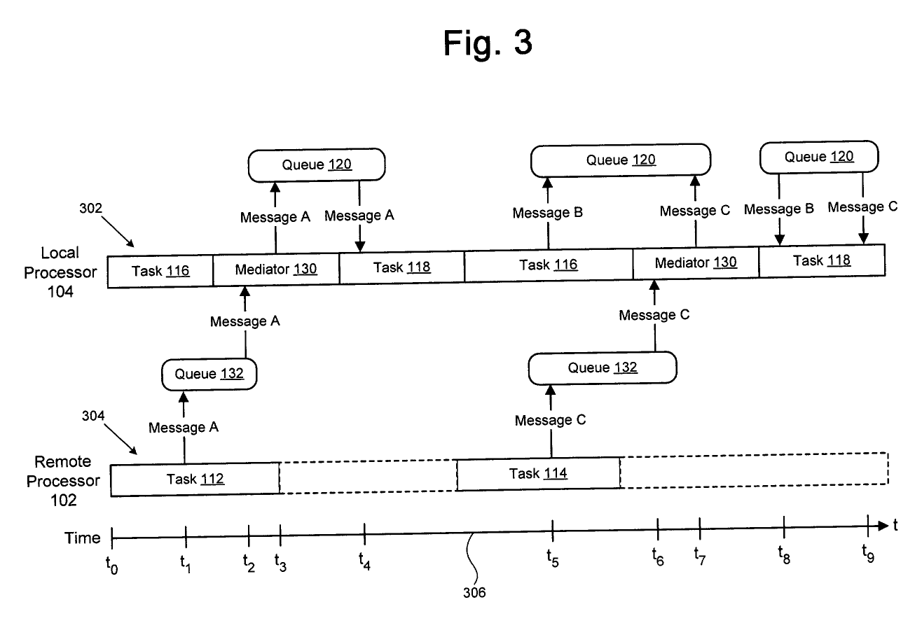

Referring now to FIG. 3, an exemplary operation of the multiprocessor system 100 of FIG. 1 is illustrated in accordance with at least one embodiment of the present invention. Execution sequence 302 represents an execution sequence of the local tasks 116, 118 and the mediator task 130 by the local processor 104 and execution sequence 304 represents an execution sequence of the remote tasks 112, 114 by the remote processor 102. As noted previously, the local processor 104 and/or the remote processor 102 preferably are adapted to support non-preemptive task execution. In the following example, the processors 102, 104 select tasks for execution in a strict cyclical sequence. However, other non-preemptive or preemptive scheduling techniques may be implemented using the guidelines provided herein. For example, a processor instruction may be implemented that toggles preemptiveness.

At or prior to time to of the timeline 306, the local processor 104 initiates the execution of an operation of the local task 116 and the remote processor 102 initiates the execution of an operation of the remote task 112. At time t₁ the task 112 generates message A intended for local task 118 and provides the message A for storage in the incoming message queue 132 associated with the mediator task 130. Message A includes a function pointer to a message transfer function for transferring messages to the message queue 120 of the local task 118. Prior to time t₂, the execution of task 116 terminates and the execution of the mediator task 130 is initiated. During this execution, the mediator task 130 examines the message A in its message queue 132 to identify message transfer function referenced by the function pointer of the message A. Based in part on this determination, at time t₃ the mediator task 130 executes the referenced message transfer function, resulting in the transfer of the message A from the incoming message queue 132 to the incoming message queue 120 associated with the local task 118 at time t₃. Prior to time t₄, the execution of the mediator task 130 is terminated and the execution of the task 118 is initiated. Noting that a message is stored in its incoming message queue 120, the local task 118 removes the message A from the queue 120 at time t₄ and processes the message A as appropriate.

Prior to time t₅, the execution of the local task 118 is terminated and the execution of the local task 116 is initiated at the local processor 104. At time t₅ the local task 116 generates a message B intended for the local task 118. Message B, like message A, includes a function pointer to the message transfer function for transferring messages from the message queue 132 to the message queue 120 of the task 118. Additionally, at or about time t₅, the remote task 114 generates message C also intended for the local task 118. Message C also includes a function pointer to the same message transfer function. Since two messages, message B and message C, are generated for the same task at essentially the same time, there typically would be a potential race condition if tasks 116, 114 attempted to store their respective message in the incoming message queue 120 at the same time.

However, as with the task 112, the task 114 is adapted to store messages intended for the local processor 104 in the incoming message queue 132 of the mediator task 130 associated with the remote processor 102. The local task 116, therefore, can store the message B in the message queue 120 of the task 118 while the remote task 114 stores the message C in the message queue 132 of the mediator task 130. During the next execution of the mediator task 130 (initiated prior to time t₆), the mediator task 130 can identify the message transfer function referenced by the message C and execute the referenced message transfer function, thereby transferring the message C from the message queue 132 (time t₆) and store the message C in the message queue 120 of the local task 118 at time t₇.

Prior to time t₈, the execution of the mediator task 130 is terminated and the execution of the local task 118 by the local processor 104 is initiated. The local task 118, noting that a number of messages are stored in its incoming message queue 120, extracts the message B at time t₈, processes the message B as appropriate, extracts the message C at time t₉ and then processes the message C.

As FIGS. 1-3 illustrate, a potential race condition resulting from simultaneous attempts to write a message by two or more tasks to the same incoming queue of a target local task can be minimized or avoided through the use of a mediator task 130 having a separate incoming message queue 132. In at least one implementation, no additional processing overhead is incurred between local tasks and only a relatively slight overhead (typically about twenty processor cycles) is incurred when passing messages between different processors. By comparison, conventional mutual exclusion techniques utilizing hardware locks, semaphores, spin locks, and the like typically introduce a significant processing overhead for both local tasks and remote tasks due to the engagement/disengagement of the mutual exclusion tool and/or any resulting busy wait while the protected resource is in use by another task. To illustrate, a local or remote task attempting to store a message in an incoming message queue of a processor using a hardware lock usually must engage the hardware lock prior to storing the message and then disengage the hardware lock after the storage operation is complete. During the engagement of the hardware lock, other tasks, remote or local, are unable to access the incoming message queue, potentially resulting in a busy wait state by the corresponding processor until the hardware lock is released.

Other embodiments, uses, and advantages of the invention will be apparent to those skilled in the art from consideration of the specification and practice of the invention disclosed herein. The specification and drawings should be considered exemplary only, and the scope of the invention is accordingly intended to be limited only by the following claims and equivalents thereof.

What is claimed is:

1. A method for communicating at least one message between a first processor and a second processor, the method comprising the steps of:
storing a message from a task of the first processor in a first queue associated with a first task of the second processor, the message being intended for a second task of the second processor; and
transferring the message from the first queue to a second queue associated with the second task during an execution of the first task by the second processor.

2. The method as in claim 1, further comprising the step of providing the message to the second task from the second queue during an execution of the second task by the second processor.

3. The method as in claim 1, further comprising the step of determining an intended destination task of the message during the execution of the first task, the intended destination task including the second task of the second processor.

4. The method as in claim 1, further comprising the step of transmitting the message from the task of the first processor to the second processor.

5. The method as in claim 1, further comprising the steps of:
storing a message from a third task of the second processor in the second queue during an execution of the third task by the second processor, the message from the third task being intended for the second task; and
providing the message of the third task to the second task from the second queue during an execution of the second task by the second processor.

6. The method as in claim 5, wherein the step of storing the message from the third task of the second processor and the step of storing the message from the task of the first processor occur substantially simultaneously.

7. The method as in claim 1, wherein executions of the first task and second task of the second processor are non-preemptive.

8. The method as in claim 1, further comprising the steps of:
storing a message from a task of a third processor in a third queue of the second processor associated with a third task of the second processor, the message being intended for the second task of the second processor; and
transferring the message from the third queue to the second queue during an execution of the third task by the second processor.

9. The method as in claim 1, wherein the first queue and the second queue are implemented in an internal memory resource of the second processor.

10. A system for communicating at least one message between multiple processors, the system comprising:
a first processor;
a first queue being adapted to store at least one message intended for a first task of the first processor;
a second queue being adapted to store at least one message from at least one task of a second processor, the at least one message being intended for the first task of the first processor; and
a first mediator task being adapted to transfer the at least one message intended for the first task from the second queue to the first queue during an execution of the first mediator task by the first processor.

11. The system as in claim 10, wherein the at least one message includes a function pointer referencing a message transfer function, the referenced message transfer function being adapted to direct the first processor to transfer the at least one message from the second queue to the first queue.

12. The system as in claim 11, wherein the mediator task is further adapted to execute the referenced message transfer function to transfer the at least one message from the second queue to the first queue.

13. The system as in claim 10, wherein the first queue and second queue are implemented in memory external to the first processor.

14. The system as in claim 10, wherein the first queue and second queue are implemented in an internal memory resource of the first processor.

15. The system as in claim 14, wherein the internal memory resource includes one of a group consisting of: cache, registers, and on-chip memory.

16. The system as in claim 10, further comprising:
a third queue being adapted to store at least one message from at least one task of a third processor, the at least one message being intended for the first task of the first processor; and
a second mediator task being adapted to transfer the at least one message intended for the first task from the third queue to the first queue during an execution of the second mediator task by the first processor.

17. The system as in claim 10, wherein the first mediator task includes a set of instructions executable by the first processor.

18. The system as in claim 10, wherein the execution of the first mediator task is non-preemptive.

19. The system as in claim 10, wherein the system is implemented in a network device adapted to process data transmitted over at least one network.

20. A multiprocessor system comprising:
a first processor having at least one task adapted to generate at least one message intended for at least one task of at least one other processor;
a second processor operably connected to the first processor and including:
a first task;
a first queue being adapted to store at least one message intended for the first task;
a second queue being adapted to store at least one message from at least one task of the first processor, the at least one message being intended for the first task of the second processor; and
a second task being adapted to transfer, during an execution of the second task by the second processor, the at least one message from the second queue to the first queue for use by the first task.

21. The system as in claim 20, wherein the second processor further includes:
a third task; and
a third queue being adapted to store at least one message intended for the third task; and wherein:
the second queue is further adapted to store at least one message intended for the third task from at least one task of the first processor; and
the second task is further adapted to transfer, during an execution of the second task by the second processor, the at least one message intended for the third task from the second queue.

22. The system as in claim 20, wherein the second processor further includes a third task being adapted to provide at least one message for storage in the first queue during an execution of the third task, the at least one message being intended for the first task.

23. The system as in claim 20, further comprising a third processor having at least one task adapted to generate at least one message intended for at least one task of at least one other processor; and
wherein the second processor further comprises:
a third queue being adapted to store at least one message from the at least one task of the third processor, the at least one message being intended for the first task of the second processor; and
a third task being adapted to transfer, during an execution of the third task by the second processor, the at least one message from the third queue to the first queue for use by the first task.

24. The system as in claim 20, wherein the first processor further comprises:
a third task;
a third queue being adapted to store at least one message intended for the third task;
a fourth queue being adapted to store at least one message from at least one task of the second processor, the at least one message being intended for the third task; and
a fourth task being adapted to transfer, during an execution of the fourth task by the first processor, the at least one message from the fourth queue to the third queue for use by the third task.

25. The system as in claim 20, wherein the execution of the second task is non-preemptive.

26. The system as in claim 20, wherein the system is implemented in a network device adapted to process data transmitted over at least one network.

27. A computer readable medium, the computer readable medium comprising a set of instructions being adapted to manipulate a second processor to:
store a message from a task of a first processor in a first queue of the second processor associated with a first task of the second processor, the message being intended for a second task of the second processor; and
transfer the message from the first queue to a second queue during an execution of the first task by the second processor, the second queue being associated with the second task.

28. The computer readable medium as in claim 27, wherein the message includes a function pointer to a message transfer function being adapted to transfer the message from the first queue to the second queue.

29. The computer readable medium as in claim 28, further comprising instructions to manipulate the second processor to execute the message transfer function during the execution of the first task.

30. The computer readable medium as in claim 27, further comprising instructions adapted to manipulate the second processor to:
store a message from a third task of the second processor in the second queue during an execution of the third task by the second processor, the message from the third task being intended for the second task; and
provide the message of the third task to the second task from the second queue during an execution of the second task by the second processor.

31. The computer readable medium as in claim 27, wherein executions of the first task and second task by the second processor are non-preemptive.

32. The computer readable medium as in claim 27, further comprising instructions adapted to manipulate the second processor to:
store a message from a task of a third processor in a third queue associated with a third task of the second processor, the message being intended for the second task of the second processor; and
transfer the message from the third queue to the second queue during an execution of the third task by the second processor.

33. The computer readable medium as in claim 27, wherein the first processor and the second processor are implemented in a network device adapted to process data transmitted over at least one network.

34. A system for communicating messages between processors comprising:
a plurality of interconnected processors, each processor including:
a first message queue;
a first task operably connected to the first message queue;
a plurality of mediator message queues; and
a plurality of mediator tasks, each mediator task being operably connected to a different mediator message queue of the plurality of message queues and the first message queue, each mediator task being associated with a different processor of a subset of the plurality of processors, and wherein each mediator task of a processor is adapted to transfer at least one message from the corresponding mediator message queue to the first message queue of the processor during an execution of the mediator task by the processor, the at least one message being stored by a first task of another processor in the corresponding mediator message queue and intended for the first task of the processor.

35. The system as in claim 34, wherein the at least one message includes a function pointer referencing a message transfer function, the referenced message transfer function being adapted to direct a mediator task to transfer the at least one message from the corresponding mediator message queue to the first message queue of the processor.

36. The system as in claim 35, wherein the mediator task is further adapted to execute the referenced message transfer function to transfer the at least one message from the mediator message queue to the first queue.

37. The system as in claim 34, wherein the first queue and the plurality of mediator message queues are implemented in memory external to the first processor.

38. The system as in claim 34, wherein the first queue and the plurality of mediator message queues are implemented in an internal memory resource of the first processor.

39. The system as in claim 38, wherein the internal memory resource includes one of a group consisting of: cache, at least one register, and on-chip memory.

40. The system as in claim 34, each of a subset of the plurality of processors further comprises:
a second message queue;
a second task operably connected to the second message queue; and
wherein each mediator task of a processor is adapted to:
store at least one message from a first task of an associated processor in the corresponding mediator message queue, the at least one message being intended for the second task of the processor; and
transfer the at least one message from the corresponding mediator message queue to the second message queue of the processor during an execution of the mediator task by the processor.

41. The system as in claim 34, wherein the first mediator task includes a set of instructions executable by the first processor.

42. The system as in claim 34, wherein the execution of the first mediator task is non-preemptive.

43. The system as in claim 34, wherein the system is implemented in a network device adapted to process data transmitted over at least one network.
